(19) United States
(12) Patent Application Publication
(10) Pub. No.: US 2006/0068671 A1
(43) Pub. Date: Mar. 30, 2006

(54) Cushioning material for press forming and manufacturing method thereof

(76) Inventor: Akira Yoshida, Kanuma-shi (JP)

Correspondence Address: DITTHAVONG & CARLSON, P.C., Suite A, 10507 Braddock Road, Fairfax, VA, 22032, US

(21) Appl. No.: 11/238,620

(22) Filed: Sep. 29, 2005

(30) Foreign Application Priority Data
Sep. 29, 2004 (JP) JP2004-284172
Aug. 29, 2005 (JP) JP2005-247385

(51) Int. Cl. B32B 5/26; B32B 27/12; B32B 37/00

(52) U.S. Cl. 442/394; 442/381; 156/349

(57) ABSTRACT

A cushioning material according to the present invention comprises a cushioning layer and a surface layer comprising a non-thermoplastic polyimide film which is integrally bonded onto the cushioning layer without a bonding agent layer. The non-thermoplastic polyimide film is provided by heating a polyamic acid film integrally bonded onto the cushioning layer without a bonding agent and thereby imidating the polyamic acid.

### BACKGROUND OF THE INVENTION

1. Field of the Invention

The present invention relates to a cushioning material for press forming which can be used at high temperature and its manufacturing method. More particularly, it relates to a cushioning material for press forming which is used when an objective product is pressed or thermally compressed at high temperature (250° C. to 400° C.) at a step of manufacturing a precision device component having a laminated structure (referred to as the laminated board in this specification hereinafter), that is, a printed board such as a copper-clad laminated board, a flexible printed circuit board or a multilayer laminated board, or an IC card, or a liquid crystal display panel, or a ceramics laminated board.

2. Description of the Background Art

In manufacturing the laminated board such as the printed circuit board at a step of press forming or thermal compression bonding, a method in which a laminated board material 3 to be pressed is sandwiched between hot plates or compression plates 1 and 2 and a predetermined pressure and temperature are applied is used as shown in FIG. 6. In order to provide a product of great precision, it is necessary to interpose a flat cushioning material 4 between the hot plate or compression plate 1 or 2 and the laminated board material 3 and apply heat and pressure to the laminated board material 3 uniformly at an appropriate speed.

Conventionally, as the cushioning material 4 for press forming, various kinds of materials such as kraft paper, organic or inorganic fiber bonded by a binder, rubber, nonwoven fabric, and laminated body of rubber and nonwoven fabric are used. Other than the kraft paper, they are repeatedly used for pressing in general.

Recently, high performance such as high heat resistance, high frequency, low dielectric constant, decreased thickness or the like is required for the recent laminated board, and as a resin used in the laminated board, thermoplastic polyimide, polytetrafluoroethylene (PTFE), a liquid crystal polymer and the like which have high melting point and high curing temperature are increasingly used. Accordingly, a press forming temperature for the laminated board material becomes as high as 250° C. to 400° C. A conventional cushioning material for press forming has no heat resistance against such high temperature condition, so that its property is lowered by thermal deterioration in an early stage of press forming and cannot be used.

Japanese Unexamined Patent Publication No. 2002-326302 discloses a heat-resistant cushioning material in which a thermally fusion bonding film is sandwiched between a cushioning layer and a heat-resistant film and integrally bonded. According to this heat-resistant cushioning material, after it is used repeatedly at a temperature higher than a melting point of the thermally adhesive film, the heat-resistant film is removed from the cushioning layer, and a wrinkle could be generated or the heat-resistant film could be damaged.

Japanese Unexamined Patent Publication No. 2003-145567 discloses a cushioning material using organic fiber (polybenzazole fiber or the like) having high heat resistance. However, when a cover layer such as a film is not provided on a surface of the cushioning material disclosed in this document, contamination such as fuzz is generated and a defect caused by a recess in a surface of the laminated board could be generated. In addition, even when the cover layer is provided on the surface of the cushioning material, a bonding agent which can resist the high temperature of 250° C. to 400° C. is hardly found.

Japanese Unexamined Patent Publication No. 2003-145567 also discloses a cushioning material in which upper and lower nonwoven fabric layers are bonded by a bonding reinforcement layer. According to one example of the bonding reinforcement layer, a bonding agent of fluoro rubber is applied to both surfaces of a glass cloth. Even in such cushioning material, after it is used at high temperature, the bonding agent deteriorates and the upper and lower nonwoven fabric layers could be removed and the like.

### SUMMARY OF THE INVENTION

The present invention was made to solve the above problems and it is an object of the present invention to provide a cushioning material for press forming which is superior in cushioning property, temporal stability, heat buffering property even under a high-temperature condition and can be repeatedly used without generating contamination such as fuzz or delamination.

A cushioning material for press forming according to the present invention comprises a cushioning layer, and a layer comprising a non-thermoplastic polyimide film which is integrally bonded onto the cushioning layer without a bonding agent layer.

The cushioning layer comprises woven fabric, nonwoven fabric paper or their complex of heat-resistant synthetic fiber or metal fiber. When nonwoven fabric, woven fabric or paper of heat-resistant fiber such as polybenzazole fiber is used for the cushioning material which becomes a core, the non-thermoplastic polyimide film prevents the contamination such as the fuzz. In addition, since the non-thermoplastic polyimide is aromatic polyimide, it is not melted even at high temperature because of strong intermolecular force. Therefore, according to the cushioning material in which its surface layer comprises the non-thermoplastic polyimide film, for example, it provides the superior cushioning property, temporal stability, heat buffering property even under a high-temperature condition and the surface layer is not separated. In addition, when the non-thermoplastic polyimide film is used as a middle layer, it keeps adhesion between the upper and lower layers under the high-temperature condition to prevent the separation of the layer.

According to one embodiment, as polyimide of the surface layer material, non-thermoplastic type is used. Thermosetting polyimide does not have sufficient heat resistance. When the surface layer is formed of thermoplastic polyimide, the surface layer is melted during press forming and there are problems such that it is separated from the cushioning layer of the core or adhered to a hot plate or a compression plate. Meanwhile, when the surface layer is formed of the non-thermoplastic type of polyimide, although it is not separated from the cushioning layer nor adhered to the hot plate or the compression plate during the press forming, there is a problem such that non-thermoplastic polyimide cannot be bonded to the cushioning layer by fusion bonding and the like. Thus, although it is considered that the non-thermoplastic polyimide film is bonded to the cushioning layer using a bonding agent, in this case, the bonding agent deteriorates because of heat during the press forming at high temperature and the non-thermoplastic polyimide film is separated from the cushioning layer and the like. In order to solve the above problems, according to a preferred embodiment of the present invention, the surface layer comprising the non-thermoplastic polyimide film is integrally bonded onto the cushioning layer without a bonding agent layer. In addition, the surface layer comprising the non-thermoplastic polyimide film may be provided on either a front or a rear surface of the cushioning layer or may be provided on both surfaces thereof.

Since non-thermoplastic polyimide is used for the surface layer, heat resistance and durability is more improved as compared with the case where the thermosetting type of polyimide or the thermoplastic type of polyimide is used. In addition, since the surface layer comprising the non-thermoplastic polyimide is directly laminated and integrated without a bonding agent layer, a problem caused by heat deterioration of the bonding agent is not generated and the separation between the layers is not generated under the high-temperature usage condition. Furthermore, when the non-thermoplastic polyimide film is used as a middle layer instead of the surface layer, the same effect can be provided.

When the cushioning layer contains fiber, a part of this fiber preferably gets in the non-thermoplastic polyimide film.

According to another embodiment, as a middle layer material between the upper and lower layers, the non-thermoplastic type of polyimide is used. The upper and lower layers are both cushioning layers, for example. Alternatively, one is the cushioning layer and the other is a film or a plate. According to this embodiment, the middle layer comprising the non-thermoplastic polyimide film is integrally bonded between the upper and lower layers without a bonding agent layer.

According to each embodiment, preferably, the non-thermoplastic polyimide film is provided by heating a polyamic acid film and thereby imidating the polyamic acid.

The cushioning material for press forming having the above constitution is manufactured by the following method. That is, the method of manufacturing the cushioning material for press forming according to the present invention comprises the following steps.

(a) A laminating step of laminating a cushioning layer and a polyamic acid film

(b) An integrally bonding step of integrally bonding the cushioning layer and the polyamic acid film by hot pressing the laminated body

(c) A non-thermoplastic polyimide film forming step of imidating the polyamic acid film on the cushioning layer by heating the integrally bonded body to form a non-thermoplastic polyimide film on a surface of the cushioning layer

According to the above method, since the relatively plastic polyamic acid film which is a precursor of polyimide is formed on the cushioning layer, the polyamic acid film and the cushioning layer can be integrally bonded by hot press under a condition of high temperature and high pressure. Then, when the polyamic acid film is heated and imidated (dehydrated), the non-thermoplastic polyimide film having high heat resistance can be provided.

Since the non-thermoplastic polyimide film of the surface layer or the middle layer is formed by the above method, the fiber forming the cushioning layer partially gets into the non-thermoplastic polyimide film in the cushioning material finally provided. As described above, the non-thermoplastic polyimide film of the cushioning material according to the present invention is provided by heating the polyamic acid film integrally bonded onto the cushioning layer without a bonding agent and thereby imidating it.

Preferably, the heating in the non-thermoplastic polyimide film forming step (c) is performed at 250° C. to 400° C. If the heating temperature is too low, imidation is not realized enough. Meanwhile, if the heating temperature is too high, the non-thermoplastic polyimide film or the cushioning layer deteriorates because of heat, so that a property of the cushioning material could be lowered.

Preferably, the method of manufacturing the cushioning material for press forming comprises a polyamic acid film preparing step of forming the polyamic acid film on a release film before the laminating step (a), and the laminating step (a) is performed so that the polyamic acid film formed on the release film may come in contact with the cushioning layer and comprises a step of removing the release film from the laminated body after the integrally bonding step (b).

More preferably, the polyamic acid film preparing step comprises a step of coating a solution of polyamic acid on a release film, and a step of making the polyamic acid solution into a film by drying the polyamic acid solution on the release film.

According to one embodiment, the surface layer comprising the non-thermoplastic polyimide film is provided on a front surface and a rear surface of the cushioning layer. According to another embodiment, the surface layer comprising the non-thermoplastic polyimide film may be provided either the front surface or the rear surface of the cushioning layer. Preferably, the cushioning layer comprises woven fabric, nonwoven fabric, paper or their complex.

According to another embodiment, the cushioning layer comprises an upper cushioning layer and a lower cushioning layer, and the laminating step (a) comprises a step of sandwiching the polyamic acid film between the upper and lower cushioning layers.

A cushioning material for press forming according to still another embodiment comprises a cushioning layer and a second layer comprising a film or a plate, in which the layer comprising the non-thermoplastic polyimide film is integrally bonded between the cushioning layer and the second layer without a bonding agent layer. A method of manufacturing the cushioning material for press forming according to this embodiment comprises a polyamic acid film preparing step of forming a polyamic acid film on the second layer comprising the film or the plate before the laminating step (a). Thus, the laminating step (a) is performed so that the polyamic acid film formed on the second layer may come in contact with the cushioning layer, and the cushioning layer and the second layer and the polyamic acid film sandwiched between them are integrally bonded by the integrally bonding step (b), and the polyamic acid film is imidated to form the non-thermoplastic polyimide film on the cushioning layer by the non-thermoplastic polyimide film forming step (c).

Since the second layer comprising the film or the plate has to have heat resistance more than a usage temperature, although a metal material such as aluminum, copper or stainless steel is used in general, a synthetic resin having heat resistance which is the same or more than that of the non-thermoplastic polyimide can be used. In order to increase bonding force between the second layer and the non-thermoplastic polyimide film, a surface treatment process such as a blasting process, an electrical discharging process or a primer process may be performed on the surface of the second layer.

According to each method of the embodiments, there can be provided the cushioning material for press forming in which separation between layers does not likely to occur even after it is used under the high-temperature condition.

Preferably, coating of the polyamic acid solution is adjusted so that a film thickness after dried may become 5 to 500 μm. If the thickness of the polyamic acid film is less than 5 μm, when it is integrated with the cushioning layer, an effect of preventing the fuzz cannot be sufficiently provided and the bonding force between the layers in the cushioning material is not sufficiently provided. Meanwhile, if the thickness of the polyamic acid film is more than 500 μm, the polyamic acid solution is not sufficiently dried and workability could be lowered. In addition, since the polyimide resin is expensive, a cost of the cushioning material is increased.

Preferably, the polyamic acid solution is dried at a temperature of 60 to 180° C. If the drying temperature is too high, since imidation starts and it becomes difficult to perform the following processing, a preferable upper limit of the temperature is 180° C. If the drying temperature is too low, drying efficiency is lowered.

### BRIEF DESCRIPTION OF THE DRAWINGS

FIG. 1 is a view showing an example of a manufacturing method according to the present invention;

FIG. 2 is a sectional view showing an example of a cushioning material for press forming according to the present invention;

FIG. 3 is a sectional view showing another example of a cushioning material for press forming according to the present invention;

FIG. 4 is a sectional view showing still another example of a cushioning material for press forming according to the present invention;

FIG. 5 is a sectional view showing still another example of a cushioning material for press forming according to the present invention; and

FIG. 6 is a schematic view showing a conventional hot pressing manner.

### DESCRIPTION OF THE PREFERRED EMBODIMENTS

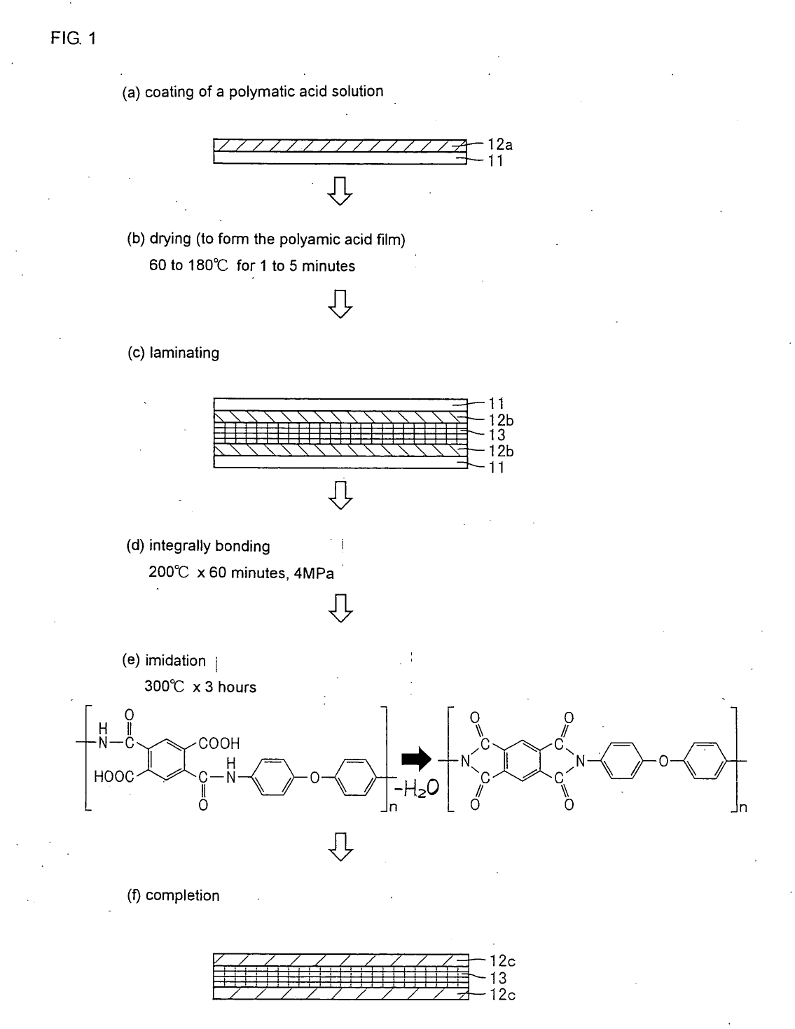

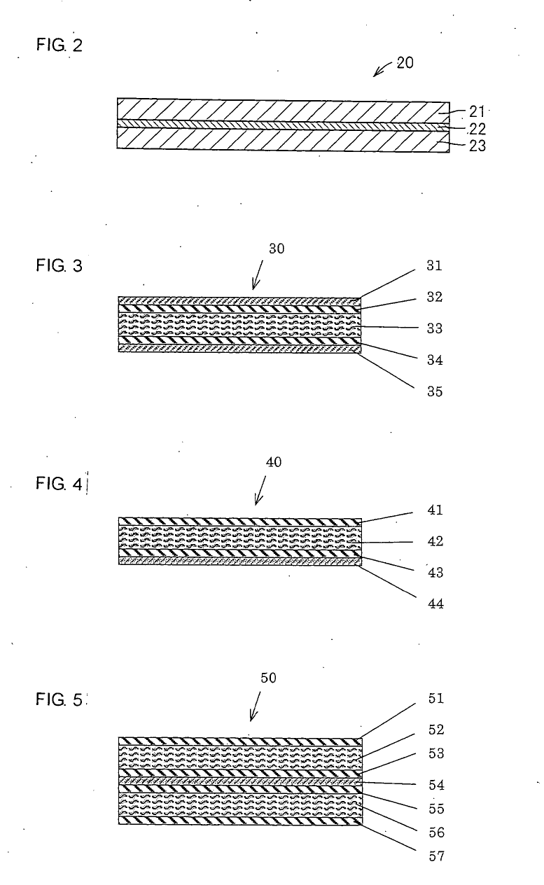

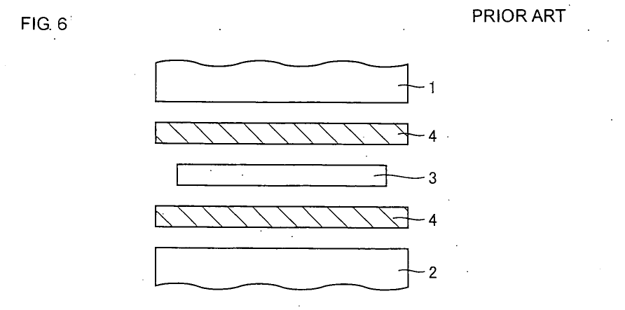

A cushioning material for press forming according to one embodiment of the present invention comprises a cushioning layer 13 and a surface layer 12c formed of non-thermoplastic polyimide and bonded to both sides of the cushioning layer 13 without an intermediate bonding agent layer as shown in FIG. 1(f). Such cushioning layer is manufactured by the following steps.

### Manufacturing Method in Embodiment 1

First, the cushioning layer 13 which serves as a core material and a release film 11 were prepared. As the cushioning layer 13, although woven fabric, nonwoven fabric, paper, or their complex may be used, polybenzazole fiber (ZYLON produced by Toyobo Co., Ltd.) having high heat resistance was used to make needle punched nonwoven fabric having a weight of 650 g/m² in this embodiment. As the release film 11, a paper or a polyethylene terephthalate film on which a silicone resin is coated and the like may be used.

As a precursor to polyimide, polyamic acid varnish 12a of dimethylacetamide solvent (U-imide B type produced by Unitika, Ltd.) was used.

As shown in FIG. 1(a), the polyamic acid solution 12a was coated on the release film 11 by a comma coater, a cast coater, a knife coater and the like. Preferably, a coating amount is adjusted so that a film thickness of a polyamic acid film 12b after dried becomes 5 to 500 μm. According to this embodiment, the coating amount was adjusted so that the film thickness of the polyamic acid film 12b after dried might become 50 μm.

As shown in FIG. 1(b), after the polyamic acid solution 12a was coated on the release film 11, it was dried at 60 to 180° C. for 1 to 5 minutes, for example to form the polyamic acid film 12b. According to this embodiment, the polyamic acid solution 12a was dried at 100° C. for 3 minutes to form the polyamic acid film 12b.

Then, as shown in FIG. 1(c), the cushioning layer 13 and the release film 11 were laminated so that the polyamic acid film 12b might come in contact with the cushioning layer 13. According to the illustrated embodiment, the release film 11 was laminated on each side of the cushioning layer 13.

Then, as shown in FIG. 1(d), the laminated body having a structure shown in FIG. 1(c) was hot-pressed so that the polyamic acid film 12b and the cushioning layer 13 were integrally bonded. A press condition was such that a pressure was 4 MPa, a temperature was 200° C., a time was 60 minutes, for example. After this hot press, the laminated body was cooled for 15 minutes. After the integral bonding, the release film 11 was removed from the polyamic acid film 12b.

Then, as shown in FIG. 1(e), the laminated body was heated in a gear oven. In this process, the laminated body was preferably heated at 250 to 400° C. for 0.5 to 10 hours. The polyamic acid was imidated (dehydrated) by this heating process as shown by a chemical structure formula and a non-thermoplastic polyimide film 12c was formed. If its heating temperature is too low, imidation is not realized enough. Meanwhile, if the heating temperature is too high, the non-thermoplastic polyimide film 12c or the cushioning layer 13 deteriorates because of the heat, so that a property of the cushioning material could be lowered. According to this embodiment, the heating process was performed at 300° C. for 3 hours.

Thus, there was provided the cushioning material in which the cushioning layer 13 and the surface layer 12c were integrally bonded without a bonding agent layer in the embodiment 1.

### Embodiment 2

According to an embodiment 2, as a precursor to polyimide, polyamic acid varnish of an NMP solvent (U-varnish-A produced by Ube Industries) was used. In the embodiment 2, a cushioning material was manufactured by the same manufacturing steps as in the embodiment 1.

### Comparative Example 1

According to a comparative example 1, a solution of thermoplastic polyimide (RIKACOAT SN-20 produced by New Japan Chemical Co., Ltd.) was coated on a release film and dried to make the thermoplastic polyimide solution into a film on the release film. Then, the release film with the thermoplastic polyimide film was laminated on both sides of a cushioning layer and hot-pressed under the same condition as in the embodiment 1 and then the release film was removed from the thermoplastic polyimide film and the laminated body of the cushioning layer and the thermoplastic polyimide film was heated. Thus, a cushioning material in the comparative example 1 was provided. The cushioning material in the comparative example 1 is different from those in the embodiments 1 and 2 of the present invention in that polyimide is already imidated in its solution state and the used polyimide is thermoplastic polyimide.

### Comparative Example 2

According to a comparative example 2, thermoplastic polyimide (RIKACOAT SN-20 produced by New Japan Chemical Co., Ltd.) was coated on a non-thermoplastic polyimide film (Kapton-H, 50 μm produced by DU PONT-TORAY Co., Ltd.) and dried. The non-thermoplastic polyimide film was laminated on a cushioning layer so that the thermoplastic polyimide might come in contact with each side of the cushioning layer and integrated by press with a high temperature and a high pressure (300° C.×10 MPa). Thus, there was provided a cushioning material in the comparative example 2. According to the comparative example 2, the thermoplastic polyimide film serves as a bonding agent between the cushioning layer and the non-thermoplastic polyimide film.

[Press Durability Test]

In order to compare performance in the embodiments 1 and 2 and comparative examples 1 and 2 with each other, press durability was tested by repeating press under a high-temperature press condition (300° C.×100 minutes+water cooling for 20 minutes, and applied pressure of 4 MPa), and the following results were provided.

Embodiment 1: No problem was generated after 100 times of press.

Embodiment 2: No problems was generated after 100 times of press.

Comparative example 1: The cushioning material was adhered to a hot plate after one press.

Comparative example 2: The surface layer material was removed after 10 times of press.

From the above results, it was confirmed that the embodiments 1 and 2 of the present invention has durability under the high temperature.

A cushioning material for press forming according to another embodiment of the present invention comprises an upper cushioning layer 21, a lower cushioning layer 23, and a middle layer 22 formed of non-thermoplastic polyimide film which is integrally bonded to the upper and lower cushioning layers 21 and 23 without an intermediate bonding agent layer. As the upper and lower cushioning layers 21 and 23, needle punched nonwoven fabric having a weight of 650 g/m² formed of polybenzazole fiber (ZYLON produced by Toyobo Co., Ltd.) was used. Such cushioning material is manufactured by the following steps.

### Manufacturing Method in Embodiment 3

As polyamic acid varnish which is a precursor to non-thermoplastic polyimide, U-varnish-S (NMP solvent) produced by Ube Industries was used and this varnish was coated on a release film. As the release film, a paper or a PET film on which a silicone resin is coated and the like may be used.

A thickness of the coated film after dried was adjusted so as to become 5 μm to 500 μm.

After the U-varnish-S was coated on the release base material, it was dried at 60 to 180° C. for 1 to 5 minutes.

The thickness of the coated film after dried was adjusted so as to become 5 μm to 500 μm. According to this embodiment, the thickness of the polyamic acid film after dried was adjusted so as to become 50 μm. Then, the polyamic acid varnish on the release film was dried at 60 to 180° C. for 1 to 5 minutes. According to this embodiment, the polyamic acid was dried at 100° C. for 3 minutes to become a film. Thus, two polyamic acid films coated on the release films were prepared.

Then, one of the release films was laminated on one face of the nonwoven fabric which was the upper cushioning layer 21 so that the surface of the polyamic acid film of the release film might come in contact with the upper cushioning layer 21. Similarly, the other one of the release films was laminated on one surface of the nonwoven fabric which was the lower cushioning layer 23 so that the polyamic acid film might come in contact with the lower cushioning layer 23.

Then, the laminated body of the upper cushioning layer 21 and the release film was hot-pressed, so that the polyamic acid film and the upper cushioning layer 21 were integrally bonded. In this process, the laminated body was pressed under a pressure of 4 MPa at 200° C. for 60 minutes. After the press, it was cooled for 15 minutes. After the integrally bonding, the release film was removed from the polyamic acid film. Similarly, the laminated body of the lower cushioning layer 23 and the release film was hot-pressed so that the polyamic acid film and the lower cushioning layer 23 were integrally bonded and then the release film was removed from the polyamic acid film.

Then, the upper cushioning layer 21 having one surface on which the polyamic acid film was bonded and the lower cushioning layer 23 having one surface on which the polyamic acid film was bonded were laminated. At this time, they were laminated so that the upper and lower cushioning layers 21 and 23 might become upper and lower surfaces and the polyamic acid films might be opposed inside the laminated body.

Then, the laminated body was hot-pressed and two polyamic acid films were integrally bonded to become one polyamic acid film. Thus, the integrally bonded body comprising the upper cushioning layer 21 and the lower cushioning layer 23 and the polyamic acid layer sandwiched between them was provided.

After the laminated body was integrally bonded, it was heated in a gear oven at 300° C. for 3 hours. Thus, the polyamic acid were imidated (dehydrated) by the above heat treatment and there was provided a cushioning material 20 comprising a non-thermoplastic polyimide film 22 as a middle layer. Thus, the cushioning material 20 was provided in the embodiment 3.

### Comparative Example 3

According to a comparative example 3, a solution of thermoplastic polyimide (RIKACOAT SN-20 produced by New Japan Chemical Co., Ltd.) was coated on a release film and dried. Then, the same steps as in the embodiment 3 were performed to provide a cushioning material. The cushioning material comprises a thermoplastic polyimide film as a middle layer. Thus, the cushioning material according to the comparative example 3 was provided. The cushioning material in the comparative example 3 is different from that in the embodiment 3 of the present invention in that polyimide is already imidated in its solution state and the used polyimide is thermoplastic polyimide.

[Press Durability Test]

In order to compare performance in the embodiment 3 with that in the comparative example 3, press durability was tested by repeating press under a high-temperature press condition (350° C.×100 minutes+cooling for 20 minutes, and applied pressure of 4 MPa), and the following results were provided.

Embodiment 3: No problem was generated after 100 times of press.

Comparative example 3: The upper and lower bonded materials were delaminated after five times of press.

From the above results, it was confirmed that the embodiment 3 of the present invention has durability under the high temperature.

Cushioning materials for press forming according to other embodiments 4 to 6 of the present invention will be described with reference to FIGS. 3 to 5. In addition, according to manufacturing methods in the embodiments 4 to 6, since a condition for forming a polyamic acid film, a press condition when laminated layers are integrated and a heating condition when polyamic acid is imidated are the same as those in the embodiments 1 to 3 of the present invention, their description will be simply made.

### Embodiment 4

As shown in FIG. 3, a cushioning material 30 for press forming comprises a cushioning layer 33 positioned in the center, an upper surface layer 31, a lower surface layer 35, two middle layers 32 and 34 formed of non-thermoplastic polyimide film which are integrally provided between the cushioning layer 33 and the upper surface layer 31 and between the cushioning layer 33 and the lower surface layer 35, respectively without an intermediate bonding agent. The cushioning layer 33 is nonwoven fabric formed of polybenzazole fiber which is the same as that in the embodiment 1. Each of the upper surface layer 31 and the lower surface layer 35 is a film or a plate and more specifically, aluminum foil, copper foil, a stainless steel plate and the like.

The cushioning material 30 for press forming is manufactured as follows. First, polyamic acid varnish is coated on one surface of the upper surface layer 31 and on one surface of the lower surface layer 35 and the varnish is dried to be a film. Here, in order to improve a bonding property between the upper and lower surface layers 31 and 35 and the non-thermoplastic polyimide film, it is preferable that a surface treatment process such as a blasting process, an electrical discharging process or a primer process is previously performed on the surface of the upper and lower surface layers 31 and 35 on which the polyamic acid varnish is to be coated. Then, the upper surface layer 31 is laminated on an upper surface of the cushioning layer 33 so that the polyamic acid film may come in contact with the cushioning layer 33. Similarly, the lower surface layer 35 is laminated on a lower surface of the cushioning layer 33 so that the polyamic acid film may come in contact with the cushioning layer 33. Then, the laminated body is hot-pressed to be integrally bonded. Furthermore, the laminated body is heated in a gear oven so that the polyamic acid is imidated. Thus, the middle layers 32 and 34 formed of non-thermoplastic polyimide are formed between the cushioning layer 33 and the upper and lower surface layers 31 and 35.

### Embodiment 5

As shown in FIG. 4, a cushioning material 40 for press forming comprises a cushioning layer 42, an upper surface layer 41 formed of non-thermoplastic polyimide and integrally bonded to an upper side of the cushioning layer 42 without a bonding agent, a lower surface layer 44 positioned on the lower side of the cushioning layer 42, and a middle layer 43 formed of non-thermoplastic polyimide and integrally bonded between the cushioning layer 42 and the lower surface layer 44 without a bonding agent. The cushioning layer 42 is nonwoven fabric formed of polybenzazole fiber like the embodiment 1. The lower surface layer 44 is a plate made of stainless steel.

The cushioning material 40 for press forming is manufactured as follows. First, polyamic acid varnish is coated on one surface of a release film for the upper surface layer 41, and the varnish is dried so that the polyamic acid becomes a film. Meanwhile, polyamic acid varnish is coated on one surface of the lower surface layer 44, and the varnish is dried so that the polyamic acid becomes a film. Here, in order to improve a bonding property between the lower surface layer 44 and the non-thermoplastic polyimide film, it is preferable that a surface treatment process such as a blasting process, an electrical discharging process or a primer process is previously performed on a surface of the lower surface layer on which the polyamic acid varnish is to be coated. Then, the release film is laminated on an upper surface of the cushioning layer 42 so that the polyamic acid film may come in contact with the cushioning layer 42. The lower surface layer 44 is laminated on a lower surface of the cushioning layer 42 so that the polyamic acid film may come in contact with the cushioning layer 42. Then, the laminated body is hot-pressed to be integrally bonded. Then, the release film bonded to the polyamic acid film on the upper surface of the cushioning layer 42 is removed. Then, the laminated body is heated in a gear oven so that the polyamic acid is imidated. Thus, the upper surface layer 41 formed of non-thermoplastic polyimide is formed on the upper surface of the cushioning layer 42 and at the same time the middle layer 43 formed of non-thermoplastic polyimide is formed between the cushioning layer 42 and the lower surface layer 44.

### Embodiment 6

As shown in FIG. 5, a cushioning material 50 for press forming comprises upper and lower cushioning layers 52 and 56, a center reinforcing layer 54 positioned between the upper and lower cushioning layers 52 and 56, an upper surface layer 51 and a lower surface layer 57 comprising non-thermoplastic polyimide films and integrally bonded to an upper side of the upper cushioning layer 52 and to a lower side of the lower cushioning layer 56, respectively without a bonding agent, and two middle layers 53 and 55 comprising non-thermoplastic polyimide films and positioned between the upper cushioning layer 52 and the center reinforcing layer 54 and between the lower cushioning layer 56 and the center reinforcing layer 54, respectively without a bonding agent. The cushioning layers 52 and 56 are nonwoven fabric formed of polybenzazole fiber like in the embodiment 1. The center reinforcing layer 54 is a plate made of stainless steel.

The cushioning material 50 for press forming is manufactured as follows. First, polyamic acid varnish is coated on one surface of a release film for each of the upper and the lower surface layer 51 and 57, and the varnish is dried so that the polyamic acid becomes a film. Thus, two films are prepared. Meanwhile, polyamic acid varnish is coated on each surface of the center reinforcing layer 54, and the varnish is dried so that the polyamic acid becomes a film. Here, in order to improve a bonding property between the center reinforcing layer 54 and the non-thermoplastic polyimide film, it is preferable that a surface treatment process such as a blasting process, an electrical discharging process or a primer process is previously performed on each surface of the center reinforcing layer 54 on which the polyamic acid varnish is to be coated. Then, the upper cushioning layer 52 and the lower cushioning layer 56 are laminated on the upper and lower surfaces of the center reinforcing layer 54, respectively. Furthermore, the release film is laminated on an upper surface of the upper cushioning layer 52 so that a coating surface of the polyamic acid may come in contact with the upper cushioning layer 52. Similarly, the release film is laminated on a lower surface of the lower cushioning layer 56 so that the coating surface of the polyamic acid may come in contact with the lower cushioning layer 56. Then, the laminated body is hot-pressed to be integrally bonded. Then, the release films attached on the polyamic acid films on the upper surface of the upper cushioning layer 52 and the lower surface of the cushioning layer 56 are removed. Furthermore, the laminated body is heated in a gear oven so that the four polyamic acid films are imidated. Thus, the upper and lower surface layers 51 and 57 comprising the non-thermoplastic polyimide films are formed on the upper surface of the upper cushioning layer 52 and the lower surface of the lower cushioning layer 56 and at the same time, the middle layers 53 and 55 comprising the non-thermoplastic polyimide films are formed between the upper cushioning layer 52 and the center reinforcing layer 54 and between the lower cushioning layer 56 and the center reinforcing layer 54, respectively.

Although the embodiments of the present invention have been described with reference to the drawings in the above, the present invention is not limited to the above illustrated embodiments. Various kinds of modifications and variations may be added to the illustrated embodiments within the same or equal scope of the present invention.

The present invention can be advantageously applied to the cushioning material for press forming used under a high-temperature condition.

What is claimed is:

1. A cushioning material for press forming comprising:
a cushioning layer;
a layer comprising a non-thermoplastic polyimide film and integrally bonded onto said cushioning layer without a bonding agent layer.

2. The cushioning material for press forming according to claim 1, wherein a part of fiber which forms said cushioning layer gets in said non-thermoplastic polyimide film.

3. The cushioning material for press forming according to claim 1, wherein said non-thermoplastic polyimide film is provided by heating a polyamic acid film integrally bonded to said cushioning layer without a bonding agent and thereby imidating the polyamic acid.

4. The cushioning material for press forming according to claim 1, wherein said layer comprising the non-thermoplastic polyimide film is provided on a front surface and a rear surface of said cushioning layer.

5. The cushioning material for press forming according to claim 1, wherein said cushioning layer comprises woven fabric, nonwoven fabric, paper or their complex.

6. The cushioning material for press forming according to claim 1, wherein said cushioning layer comprises an upper cushioning layer and a lower cushioning layer, and
said layer comprising the non-thermoplastic polyimide film is integrally bonded between said upper and lower cushioning layers.

7. The cushioning material for press forming according to claim 1, comprising said cushioning layer and a second layer comprising a film or a plate, wherein said layer comprising the non-thermoplastic polyimide film is integrally bonded between said cushioning layer and said second layer without a bonding agent layer.

8. A method of manufacturing a cushioning material for press forming comprising:
a laminating step of laminating a cushioning layer and a polyamic acid film to provide a laminated body;
an integrally bonding step of integrally bonding said cushioning layer and said polyamic acid film by hot-pressing said laminated body; and
a non-thermoplastic polyimide film forming step of imidating said polyamic acid film on said cushioning layer by heating said integrally bonded body to form a non-thermoplastic polyimide film on a surface of said cushioning layer.

9. The method of forming the cushioning material for press forming according to claim 8, wherein heating in said non-thermoplastic polyimide film forming step is performed at 250° C. to 400° C.

10. The method of manufacturing the cushioning material for press forming according to claim 8, comprising:
a polyamic acid film preparing step of forming polyamic acid film on a release film before said laminating step,
wherein said laminating step is performed so that said polyamic acid film formed on the release film may come in contact with said cushioning layer, and comprises a step of removing said release film from said laminated body after said integrally bonding step.

11. The method of manufacturing the cushioning material for press forming according to claim 10, wherein said polyamic acid film preparing step comprises a step of coating a solution of polyamic acid on the release film, and a step of making the polyamic acid into a film by drying the polyamic acid solution on said release film.

12. The method of manufacturing the cushioning material for press forming according to claim 11, wherein coating of said polyamic acid solution is adjusted so that a film thickness after dried may become 5 to 500 μm.

13. The method of manufacturing the cushioning material for press forming according to claim 11, wherein said polyamic acid solution is dried at a temperature of 60 to 180° C.

14. The method of manufacturing the cushioning material for press forming according to claim 8, wherein said cushioning layer comprises an upper cushioning layer and a lower cushioning layer, and
said laminating step comprises a step of sandwiching said polyamic acid film between said upper and lower cushioning layers.

15. The method of manufacturing the cushioning material for press forming according to claim 8, comprising a step of polyamic acid film preparing step of forming a polyamic acid film on a second layer comprising a film or a plate before said laminating step, wherein
said laminating step is performed so that said polyamic acid film formed on said second layer may come in contact with said cushioning layer, and
said cushioning layer and said second layer and said polyamic acid film sandwiched between them are integrally bonded by said integrally bonding step.
